(19) United States
(12) Patent Application Publication
(10) Pub. No.: US 2009/0211417 A1
(43) Pub. Date: Aug. 27, 2009

(54) Programmable Slicer With Powered Food Carriage

(75) Inventors: Samuel A. Rummel, Pooler, GA (US); Guangshan Zhu, Richmond Hill, GA (US); Shahram Shariff, Savannah, GA (US)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 11/917,064

(22) PCT Filed: Jun. 28, 2006
(86) PCT No.: PCT/US2006/025344

§ 371 Date: May 19, 2008

Related U.S. Application Data
(60) Provisional application No. 60/694,834, filed on Jun. 29, 2005.

(51) Int. Cl. B26D 7/06; B26D 7/01; B26D 5/00; B23Q 15/00

(52) U.S. Cl. 83/74; 83/707; 83/715; 83/717; 83/72

(57) ABSTRACT

A slicer for use in slicing a food product includes a slicer body. A slicer knife is mounted to the slicer body. A linear motor may be provided to move a food product support carriage. A slicer may also include stroke length setting adjustment features.

### TECHNICAL FIELD

The present application relates to slicers and more particularly to a slicer with a linear motor powered food carriage and/or slicer with programmable stroke length.

### BACKGROUND

Typical food slicers have a base, a slicing knife for use in cutting a food product, a gauge plate for positioning the food product relative to the slicing knife and a carriage for supporting the food product as it is cut by the slicing knife. Typically, in slicers with powered carriages, the carriage is driven using a rotary motor and a mechanical linkage or other transmission arrangement that converts rotational output of the rotary motor into linear motion that drives the carriage a fixed travel distance between a start position and a fixed stop position. In some instances, an engage/disengage mechanism between the carriage and the transmission is provided for switching between automatic and manual slicing operations.

### SUMMARY

In one aspect, a food product slicer includes a slicer body and a slicer knife mounted for rotation relative to the slicer body, the knife having a peripheral cutting edge. A food product support carriage is mounted for movement back and forth past the slicer knife. A carriage drive effects automated movement of the carriage back and forth past the slicer knife. The carriage drive includes a linear motor having a forcer and a stator each having at least one magnetic field generator, the forcer movable along a linear path relative to the stator, the forcer mechanically linked with the carriage to effect automated movement of the carriage.

In another aspect, a food product slicer includes a variable stroke length setting feature. The slicer includes a slicer body and a slicer knife mounted for rotation relative to the slicer body, the knife having a peripheral cutting edge. A food product support carriage is mounted for movement back and forth past the slicer knife along a carriage movement path.

A drive automatically drives the carriage back and forth past the slicer knife for automatic food product slicing operations. An encoder arrangement provides an output for tracking position of the carriage along the carriage movement path. A control is connected with the drive and the encoder arrangement, the control including memory for storing both a carriage stroke start position and a carriage stroke end position, enabling carriage stroke length to be set by adjusting the stored carriage stroke start position and/or the stored carriage stroke end position.

In a further aspect, a food product slicer includes a variable stroke length setting feature. The slicer includes a slicer body and a slicer knife mounted for rotation relative to the slicer body, the knife having a peripheral cutting edge. A food product support carriage is mounted for movement back and forth past the slicer knife along a carriage movement path. A drive automatically drives the carriage back and forth past the slicer knife for automatic food product slicing operations. An encoder arrangement provides an output for tracking position of the carriage along the carriage movement path. A control is connected with the drive and the encoder arrangement, the control including memory for storing a carriage stroke start position, the control automatically identifying and storing the carriage stroke start position based upon automatically identifying location when the food product is positioned proximate to the peripheral cutting edge of the slicer knife.

### BRIEF DESCRIPTION OF THE DRAWINGS

FIG. 1 is a partial, front view of an embodiment of a slicer;

FIG. 2 is a partial, side view of the slicer of FIG. 1;

FIG. 3 is a perspective view of an embodiment of a linear motor for use in the slicer of FIG. 1;

FIG. 4 is a diagrammatic view of an embodiment of a stator for use in the linear motor of FIG. 3;

FIG. 5 is a diagrammatic view of an embodiment of a forcer for use in the linear motor of FIG. 3;

FIG. 6 is a perspective view of another embodiment of a linear motor including multiple forcers;

FIG. 7 is a schematic illustration of the linear motor of FIG. 3 connected to slicer components;

FIGS. 8-10 illustrate a method of programming the slicer of FIG. 1 to slice a food product;

FIGS. 11 and 12 illustrate a method of programming the slicer of FIG. 1 to slice another food product;

FIG. 13 illustrates a food product being cut in the method illustrated by FIGS. 8-10; and

FIG. 14 illustrates a food product being cut in the method illustrated by FIGS. 11 and 12.

### DETAILED DESCRIPTION

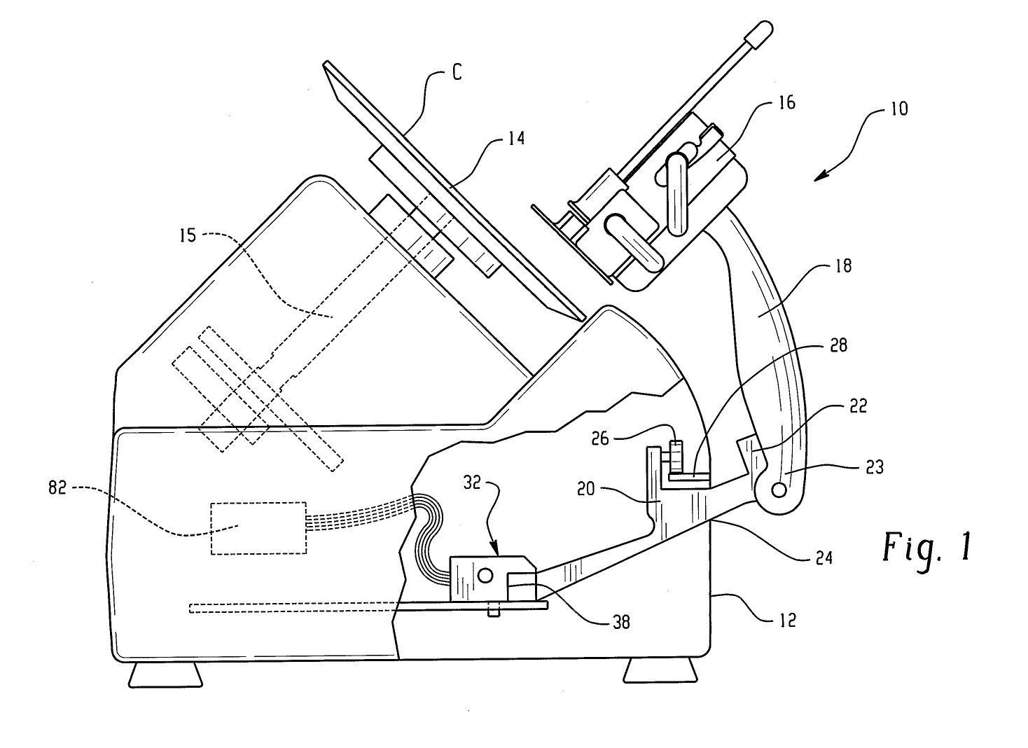

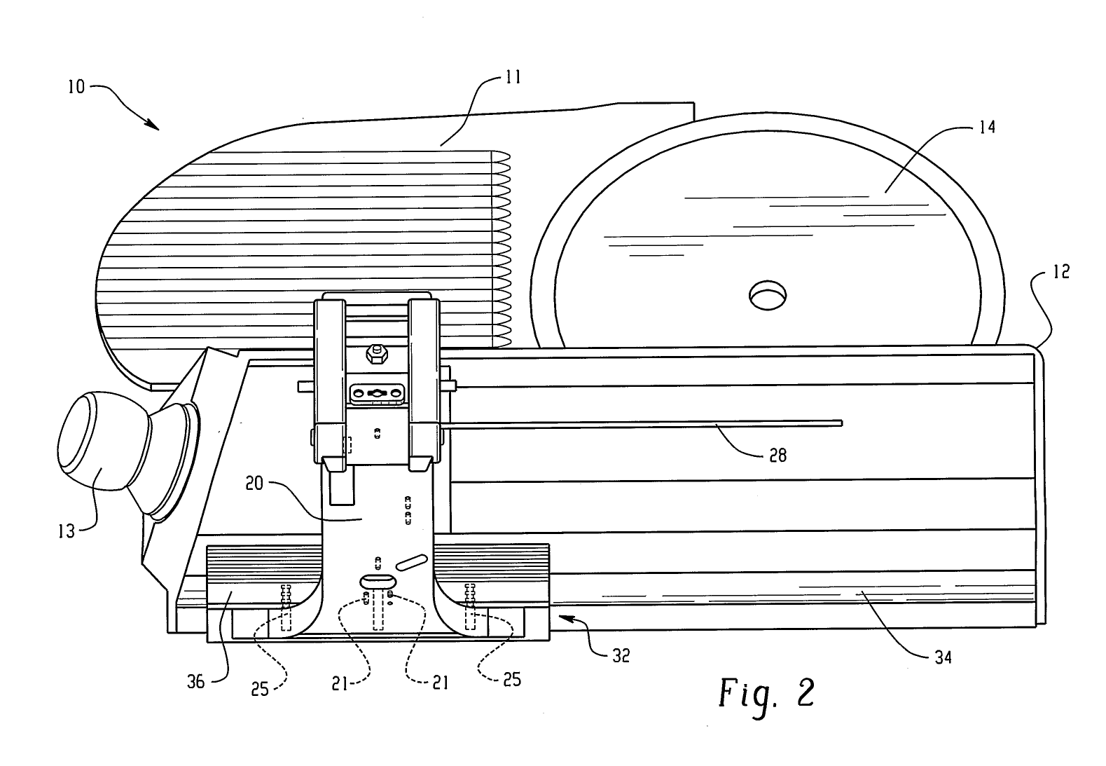

As shown in FIGS. 1 and 2, a food product slicer 10 includes a housing 12 and a circular, motor-driven slicing knife 14 that is rotatably mounted to the housing on a fixed axis shaft 15. A food product can be supported on a food carriage 16 which moves the food product to be sliced through a cutting plane C and past the rotating slicing knife 14. The food carriage 16 reciprocates in a linear path in a direction generally parallel to the cuffing plane C. The slicer includes a gauge plate 11 along which food product slides as it moves toward the knife 14. The gauge plate is movable via rotation of a handle 13 so as to adjust gauge plate position between a position aligned with the knife cutting edge and multiple positions displaced from the cutting edge of the knife (i.e., rearward in the view of FIG. 2) to vary the slice thickness of food product cut by the knife 14.

Food carriage 16 is mounted on a carriage arm 18 that orients the food carriage at the appropriate angle (typically perpendicular) to the slicing knife 14. The carriage arm 18 is supported on a transport 20. The transport has mounting structure 22 to receive the foot 23 of the carriage arm 18. Transport 20 reciprocates in a slot 24 within the housing 12. The transport 20 includes a roller 26 that rides along track 28 with the track 28 providing support for the carriage arm 18 as the carriage arm reciprocates within slot 24.

A linear motor 32 is used to move the transport 20, carriage arm 18 and food carriage 16 assembly. Referring particularly to FIG. 2, linear motor 32 includes a stator 34 in the form of an elongated thrust rod or tube and a forcer 36 (sometimes referred to as an armature) in the form of a box-like housing that moves relative to the stator. Stator 34 is fixedly mounted within the housing 12 and is received by the forcer 36, which can move along the length of the stator. As used herein, “stator” refers generally to the stationary component of the linear motor 32 and “forcer” refers generally to the moveable component of the linear motor. As such, in some instances, the rod may be the moveable component, i.e., the forcer and the box-like housing may be the stationary component, i.e., the stator.

In the illustrated example, transport 20 is mounted within a receiving portion 38 (FIG. 1) of the forcer 36 using alignment pins 21 and fasteners 25 (shown by dotted lines in FIG. 2). Any suitable mounting arrangement can be used. For example, as an alternative to fasteners, the forcer 36 may be formed with the transport 20, such as by casting the forcer and transport together. Alternatively, the transport 20 may be separable from the forcer 36. This may be accomplished through use of releasable engaging structure (not shown) such as releasable clamps that can be actuated to grasp and release the forcer 36 and/or transport 20. This can allow for independent movement of the forcer 36 and transport 20 relative to each other with the engaging structure disengaged. In some embodiments, the stator 34 may be formed with the housing 12, such as by casting the stator and the housing together.

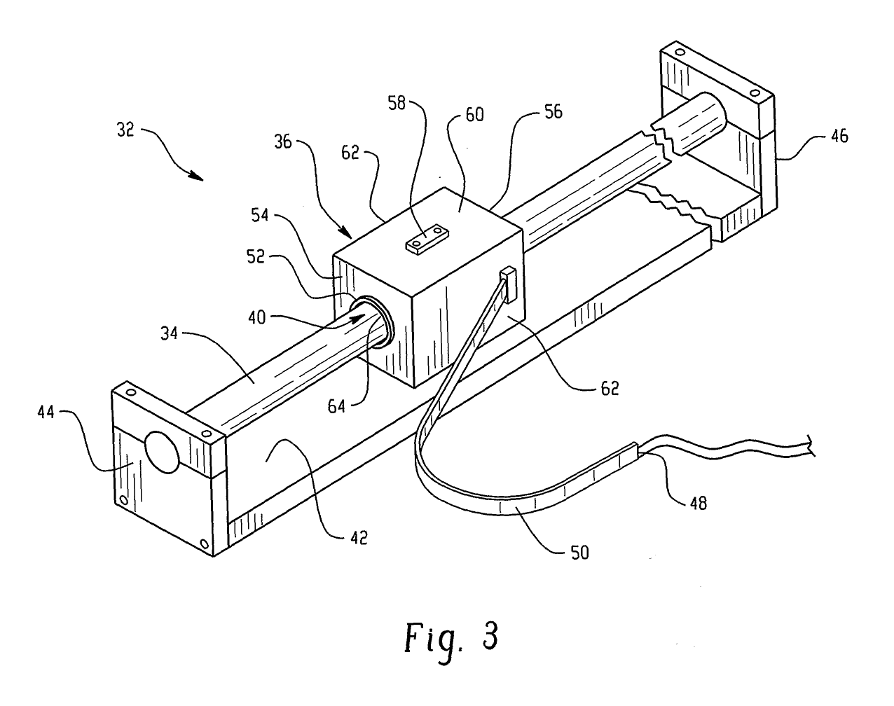

Referring now to FIG. 3, an exemplary linear motor 32 is a thrust rod-type linear motor that includes stator 34, which is a central thrust tube and forcer 36 that receives the stator within opening 40 and moves along the length of the stator using digitally controlled magnetic fields. Stator 34 is fixedly mounted to frame 42 using end brackets 44 and 46, however, other mounting configurations for the stator are possible. In some instances, frame 42 including end brackets 44, 46 are formed of a non-ferromagnetic material. Forcer 36 includes connecting structure 58 for use in connecting the forcer to the carriage assembly. In some embodiments, the connecting structure 58 may include holes, brackets, fasteners, etc. In some instances, there is an intermediate connecting structure (not shown) disposed between the forcer 36 and carriage assembly that is used to connect the forcer to the carriage assembly. While connecting structure 58 is shown at a top 60 of the forcer 36, the connecting structure can be located at a side 62 of the forcer to mount the carriage assembly thereto.

Bearings 52 (see also FIG. 5) are located at ends 54 and 56 of the forcer and support the forcer on the stator 34 to reduce friction between the stator 34 and forcer 36 during use. A gap 64 (in some embodiments, 0.16 inch) is provided between the stator 34 and the forcer 36. The gap 64 can promote cooling and ease design tolerances. An electrical connector 48 electrically connects the forcer 36 to a power source (not shown). The electrical connector 48 can include a retractable portion 50. Since the forcer 36 typically moves along the length of the stator 34 during operation, the electrical connector 48 may be flexible. In some embodiments, as will be described in greater detail below, the linear motor 32 may further be electrically connected to or in communication with components of the slicer 10, for example, using electrical connector 48.

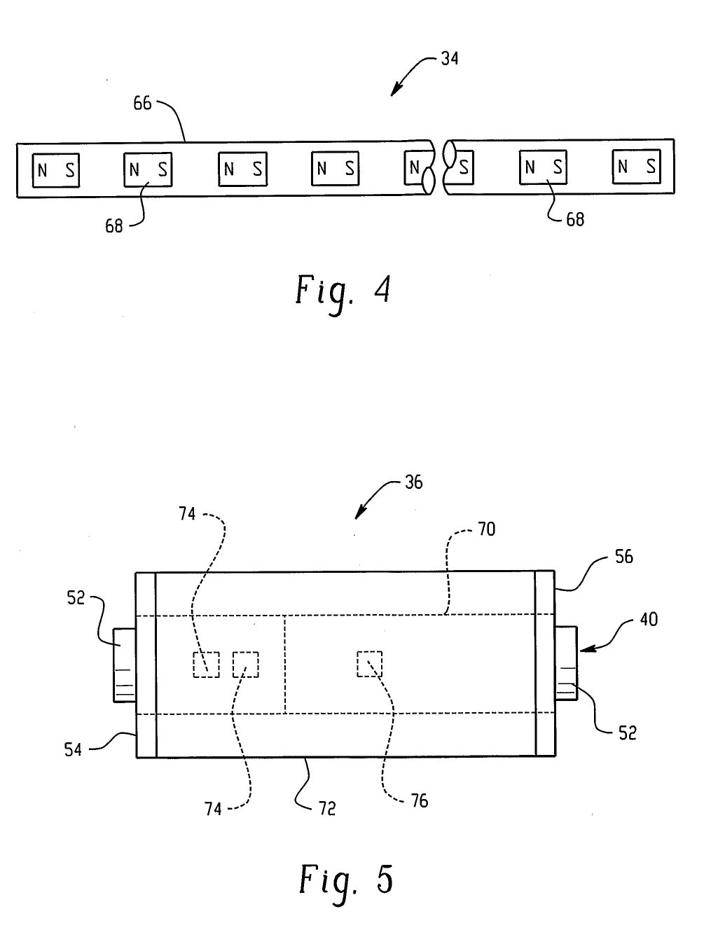

The exemplary embodiment of FIG. 4 shows stator 34 in the form of a hollow rod 66. In some embodiments, the hollow rod 66 is extruded from a non-ferromagnetic material such as 300 series stainless steel. A series of high intensity permanent magnets 68 generate magnetic flux and are located within the hollow rod 66 at evenly spaced intervals along the length of the hollow rod. The magnets 68 can be separated by spacers (in some embodiments, formed of a ferromagnetic material). As shown by FIG. 4, the poles of the magnets 68 are arranged in an alternating sequence of N S N S N S. In another embodiment, the poles are arranged such that like poles face each other, such as N S S N N S. Various such pole sequences are described in UK patent no. GB 2,079,068.

Referring to FIG. 5, forcer 36 includes a housing 72 and windings 70 disposed about an inner diameter of opening 40. The windings 70 generate magnetic flux and can be embedded into material forming the housing 72, such as a polymer or aluminum and alloys. Hall effect sensors 74 are located in the housing 72 and are used to detect the position of the forcer 36 over the length of rod 66 using a reference magnetic field. In some embodiments, the sensors 74 provide an analog sin/cos 1Vₚ₋ₚ encoder feedback signal. More position sensors may be added internal or external of the forcer 36 to achieve absolute positioning over the length of rod 66 without any need for homing the forcer (e.g., back to zero position) at start-up. Position sensors other than Hall effect sensors can be employed to determine the absolute or relative position of the forcer 36. In one embodiment, forcer 36 may also include a thermal sensor 76 for use in detecting a temperature condition. The forcer body may be formed with fins, cooling channels or other heat dissipation enhancing structure.

The linear motor 32 converts energy directly into linear mechanical force and can have a relatively high energy efficiency, for example, compared to a motor having rotational output. Since the linear motor 32 converts energy directly into linear motion, no mechanical conversion components are required to convert rotational motion into linear motion, which can reduce the amount of space required for the motor/carriage assembly within housing 12 and the overall operational noise level. Light weight construction of the forcer's housing 72 can result in reduced inertia, which can increase response time of the linear motor 32. Only bearings 52 may contact the stator 34, which can eliminate contact wear between the forcer housing 72 and the stator. Lightweight construction and negligible friction and backlash (i.e., an angle that is traversed before gears of a rotary-type motor again mesh when the motor is reversed) permit the rapid acceleration and resonance free stopping for accurate, repetitive positioning. In some embodiments, the linear motors 32 can provide resolution and repeatability within about 12 microns.

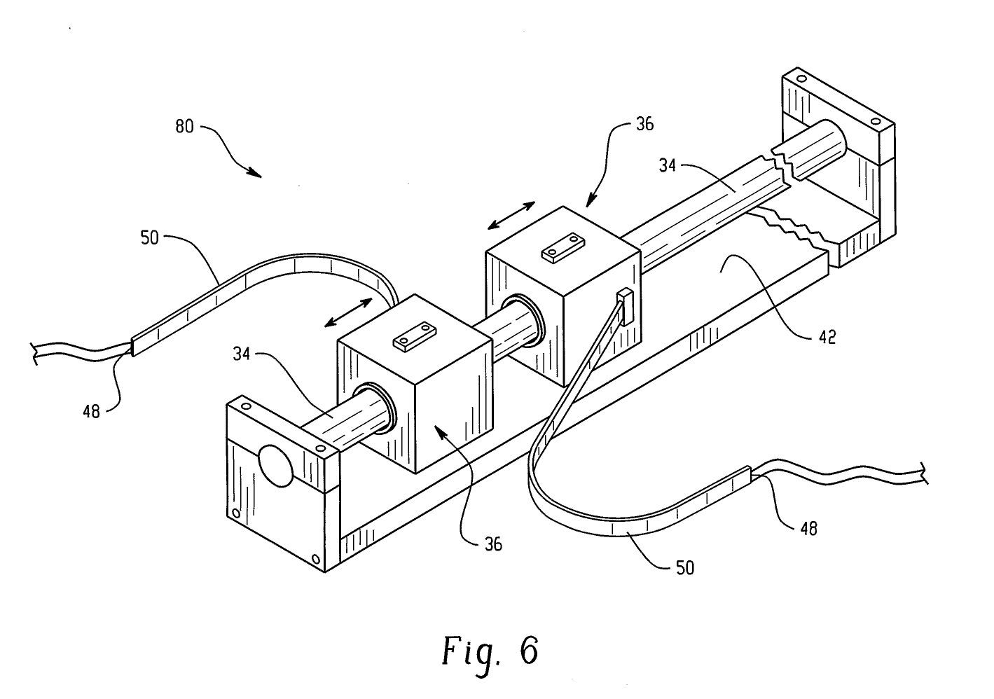

Referring now to FIG. 6, an alternative embodiment of a thrust rod-type linear motor 80 includes multiple forcers 36 that can travel along a single stator 34. In some embodiments, two, three or more forcers 36 are positioned on the stator 34. Multiple forcers 36 can increase drive force by connecting the multiple forcers 36 to the carriage assembly. In some cases, the forcers 36 can move independently of each other.

Suitable linear motors can be purchased from Copley Controls Corp. of Canton, Mass. or Harbin Electric, Inc. of Harbin, China.

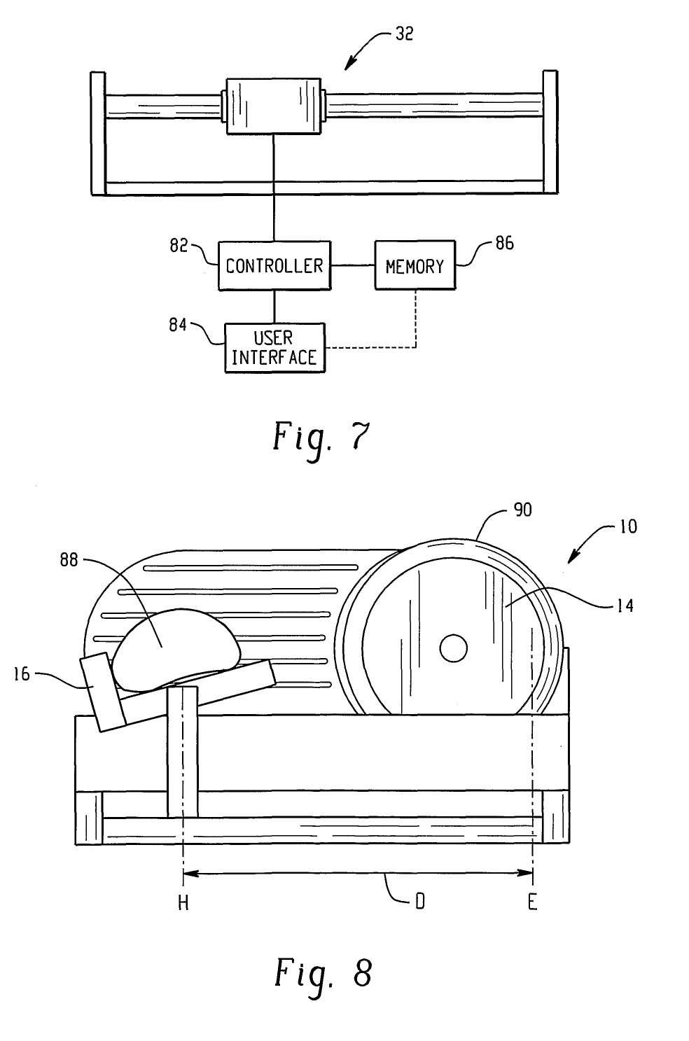

Referring to FIG. 7, as indicated above, the linear motor 32 can be in communication with components of the slicer 10 such as controller 82 (in some embodiments, the controller 82 is disposed in housing 12 (see FIG. 1)). Controller 82 can control activation, deactivation and, in some instances, other operating parameters of the linear motor 32, such as forcer velocity, forcer acceleration, start and/or stop position of forcer 36 along the length of the stator 34, etc. In some instances, the controller 82 controls operating parameters of the linear motor 32 based on indications from the position and temperature sensors 74 and 76. For example, if temperature sensor 76 detects a temperature above a pre-selected level in a fault condition, the controller may deactivate the linear motor 32 to allow the linear motor an opportunity to cool. In some cases, controller 82 is in communication with user interface 84 and operates the linear motor 32 in response to a signal therefrom that can be based on user input. In some embodiments, the controller 82 and/or user interface 84 includes or is connected to a memory 86 for storing and retrieving information using the controller 82 and/or user interface 84.

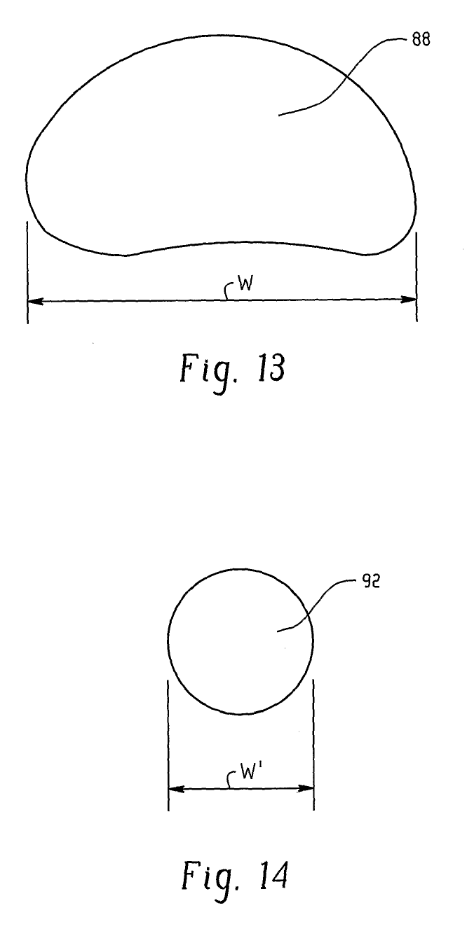

Referring to FIGS. 8-10, slicer 10 enables a reciprocation range for the carriage 16 to be set. FIG. 8 shows carriage 16 in its home position H with, for example, forcer 36 of linear motor 32 in its datum or zero position, which may correspond to the furthest distance from the slicing knife 14 that the forcer can travel along the stator 34. The carriage 16 is carrying a relatively large food product 88 to be sliced, such as turkey or roast beef. Without setting a reciprocation range, the carriage 16 in some embodiments will reciprocate between H and E. Location E may correspond to the furthest location from H that the forcer 36 can travel along the stator 34 and the distance D between H and E may correspond to the maximum travel distance of the forcer 36 along the length of the stator 34. As can be appreciated, such an arrangement can be relatively inefficient when cutting multiple slices because the width W of the food product 88 (FIG. 13) is much less than D.

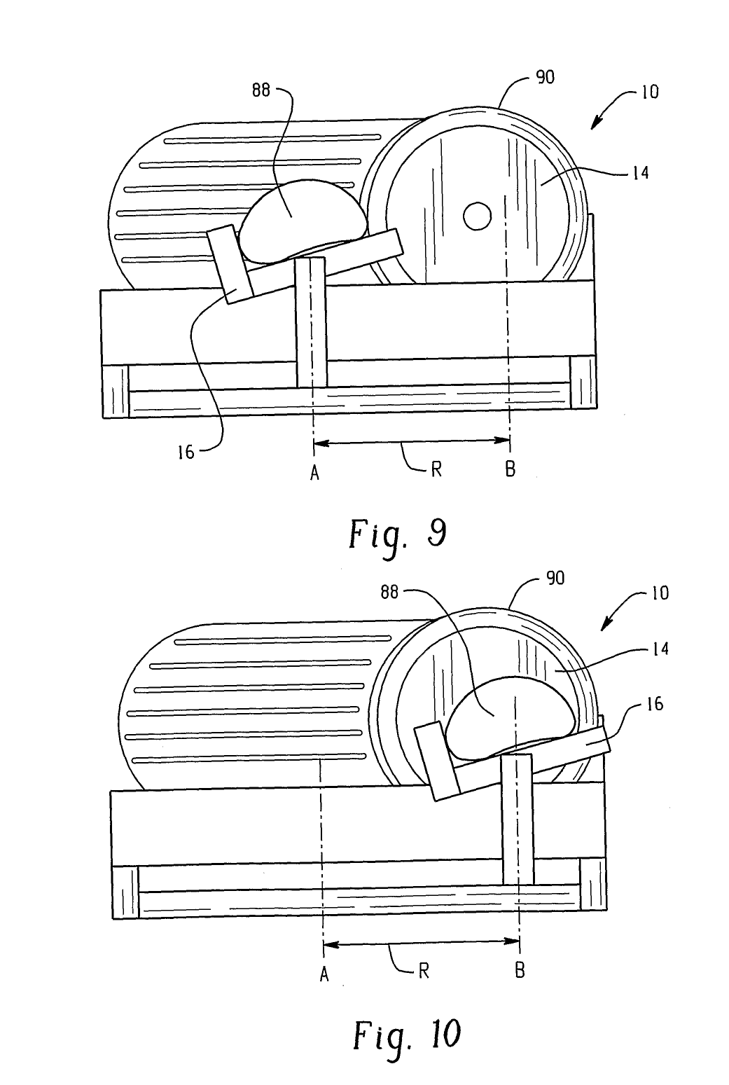

Referring to FIGS. 9 and 10, a reciprocation distance R can be set that is less than D and closer to W (FIG. 13). In one embodiment, to set R, the carriage 16 and food product 88 disposed thereon can be brought closer to the slicing knife 14 (e.g., manually) until the food product is in or is near slight contact with a cuffing edge 90 of the slicing knife 14 to define a first position A. In some instances, carriage 16 may automatically advance until food contact with the slicing knife 14 is detected (as by a load sensor) and then the carriage may automatically travel in the opposite direction for a short distance (e.g., ½ inch) to position A in order to assure that the starting point for the stroke places the edge of the food product in front of the knife. In some embodiments, carriage 16 may automatically advance to a short distance (e.g., ½ inch) from the slicer knife to position A. Position A may be detected by the encoder arrangement including position sensors 74 (FIG. 5) and can be saved into memory 86 of the slicer 10. Saving position A may occur automatically, for example, once the carriage comes to rest for a period of time. Alternatively, position A can be saved into memory upon user command, for example, by pressing a button, flipping a switch, etc. In some embodiments, the slicer 10 can automatically advance the carriage 16 using the linear motor 32 and, using a detector such as an optical or mechanically triggered detector (not shown), the slicer can automatically detect when the food product 88 comes into contact with the slicing knife 14. The slicer 10 can then automatically save the associated position in the memory 86. In some embodiments, the user may manually enter a position using a user interface and that position can be saved into memory to set position A. In certain embodiments, once position A is saved or set, the slicer 10 automatically begins a cutting operation.

Referring particularly to FIG. 10, once the reciprocation range R is set, the carriage assembly can reciprocate between position A and a second position B to cut the food product 88 into slices. Position sensors 74 (FIG. 5) are used to detect the locations along the stator 34 that correspond to the food carriage's 16 alignment with positions A and B. When positions A and B are detected, the controller 82 (FIG. 7) receives/looks for an indication that the position A, B has been detected. In response to the indication that position A or B has been detected, the controller reverses the direction of the linear motor 32. Position B may be pre-programmed, or in some embodiments, position B can be set, for example, by the user or automatically by saving position B in memory 86, as described above with respect to position A. In some instances, position B corresponds to a maximum distance the forcer 36 can travel along the stator 34.

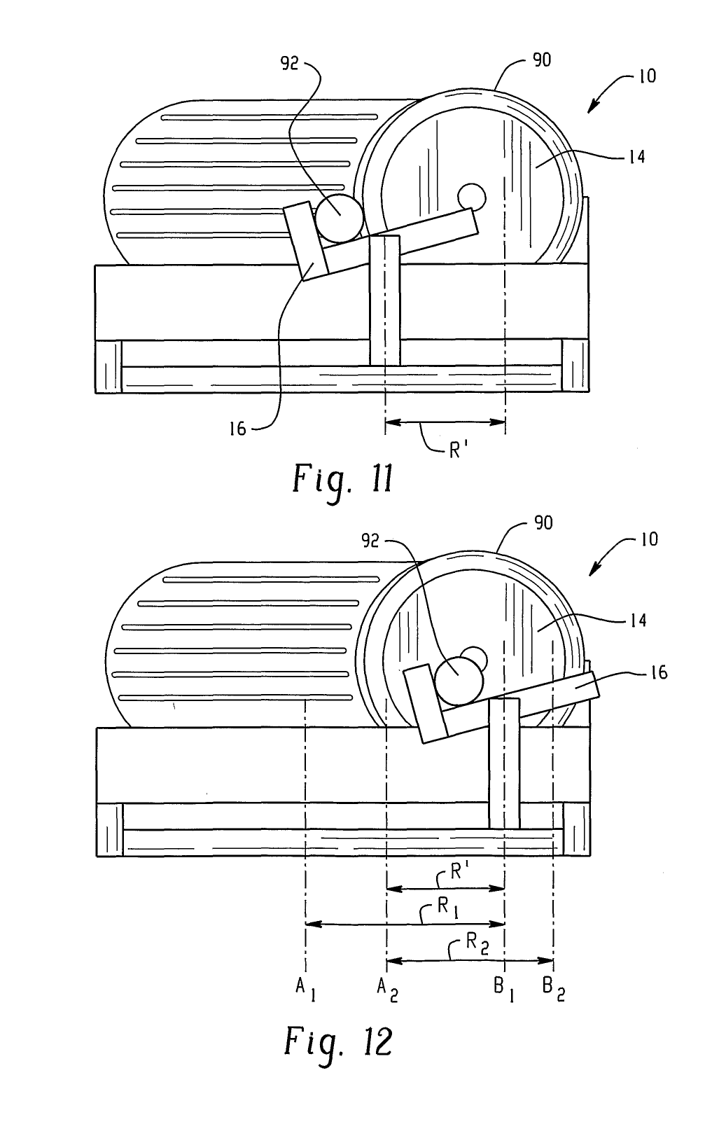

Referring to FIGS. 11 and 12, differing reciprocation ranges can be set to correspond to different food product sizes. For example, food product 92 (e.g., provolone cheese, salami, bologna, etc.) has a width W′ that is less than that of food product 88 (FIG. 14). As described above, a reciprocation distance R′ can be set that approaches W′, is less than W of FIG. 13 and that results in slices being cut from the food product 92. In some embodiments, multiple, different or overlapping ranges may be set and saved into memory, for example, R₁ and R₂ between locations A₁ and B₁ and A₂ and B₂.

The stroke length setting feature can be utilized in connection with carriage drives other than linear motors. For example, a rotating motor and encoder arrangement could be used. Additionally, any suitable method can be used to set the reciprocation range including the start and end points A and/or B. As noted above, in one embodiment, the carriage 16 can be moved to a desired start location A (or a desired end location B) and then a user can use an interface to indicate to the controller that this position is the start position (e.g., by pushing a button).

For a more automated system, the user can cut a few slices (e.g., one, two, three, four, five or more) and the controller can learn the desired reciprocation range including A and B. In another embodiment, a load sensor is employed to detect a motor load change occurring due to slicer knife contact with the food product that can be used to detect A and B (e.g., as indicated by a change in motor current for one or both of the carriage drive motor and the slicer knife drive motor). In one example, the A position may be detected by current level of at least one of the knife drive motor and the carriage drive motor exceeding a threshold level and/or the B position may be detected by current level of one of the drive motors falling back below the threshold level. In another example the A position may be detected by current level of both the knife drive motor and the carriage drive motor exceeding respective threshold levels and/or the B position may be detected by the current level of each motor falling back below its respective threshold level. While motor current level is one basis for evaluating motor load condition, other bases for detecting motor loading conditions exist, such as by examining direct changes in voltage or power or by more complex evaluations (e.g., integral or derivative analysis) of one or more of current, voltage, power or some other transitory electrical parameter. In still another example the A position may be detected by at least one load sensor separate from both the knife drive motor and the carriage drive motor. In some instances, a sensor such as a strain sensor can be used to detect a load change on a carriage grip. In other embodiments, the slicer 10 can automatically advance the carriage 16 using the linear motor 32 and, using a detector such as an optical or mechanically triggered detector (not shown), the slicer can automatically detect when the food product 88 is located proximate the knife edge. Any of the techniques noted in this paragraph provide a basis for automatically determining proper carriage location corresponding to placement of the food product proximate to the cutting edge of the knife.

In certain embodiments, A, B and R (or multiple values for A, B and R) may be stored in memory of the slicer. The values can correspond to suitable values for slicing various food products. In one example, a user interface, such as a keyboard, may include a selectable menu of various food items, such as beef and provolone. Each food item has an associated value for A, B and/or R saved in memory of the slicer that is used by the slicer to set the reciprocation range and start and finish locations for the carriage.

The slicer 10 may be also equipped with two features called “home start” and “home return.” The “home start” feature insures that when in automatic mode, the motor will not start until the carriage 16 is in the home position, e.g., position H (FIG. 8). Therefore, if the food product carriage 16 stops and it is not returned to the home position, it needs to be manually pulled back to that position before automatic operation can begin again. The “home return” feature causes the carriage to automatically return to the “home” or start position upon completion of an automatic slicing operation. Details of an automatic operation sequence are described in U.S. Pat. No. 6,845,697. A home position switch or sensor may be provided if desired for determining when the slicer is at the home position, and for setting or orienting the encoder arrangement at least when a slicer is initially powered (e.g., when initially plugged in)

Although the foregoing description references details in accordance with the illustrated embodiment, it is recognized and anticipated that various changes and modifications could be made. For example, while a thrust rod-type linear motor has been primarily described, other suitable linear motors can be used. Examples of other linear motors that may be suitable include U-shaped linear motors, forcer-platen type linear motors including linear stepper motors, linear induction motors, etc. The linear motors can be capable of operating with a variety commercial linear encoders, drive amplifiers and/or motion controllers. In a typical linear motor application, the carriage can be moved manually without resistance as long as the linear motor is not being energized. Thus, manual slicing operations can be achieved without mechanically disengaging the linear motor drive system from the carriage.

Regarding carriage speed, in one embodiment the slicer control may be configured to implement a selected one of multiple preset slicing speeds (e.g, 20 slicing strokes per minute, 30 slicing strokes per minute etc.). In another embodiment, the slicer control may be configured to implement a selected one of multiple preset average carriage movement speeds (e.g, X inches/sec, Y inches/sec etc. in accordance with established acceleration and deceleration curves) in which case the number of slicing strokes per minute may vary with stroke length. In still another embodiment the slicer control may be configured to maximize the number of slicing strokes per unit time in accordance with one or more monitored control parameters. For example, the slicer control may repeatedly accelerate, run and decelerate the carriage as fast as possible by energizing the carriage drive motor at a level so as to approach, but not exceed a set torque limit, a set load limit or some other set parameter. Alternatively, the carriage speed maximizing control could monitor both the carriage drive motor as stated above, and the knife drive motor (e.g., knife drive motor torque not to exceed a set torque limit, knife drive motor load not to exceed a set load limit, knife drive motor speed not to fall below a set speed limit or some other set parameter). Such a speed maximizing control would enable the slicer to automatically operate at speeds appropriate for the size and nature of the product loaded on the carriage, without requiring operator adjustment.

A number of embodiments have been described. Nevertheless, it will be understood that various modifications may be made.

What is claimed is:

1. A food product slicer, comprising:
a slicer body;
a slicer knife mounted for rotation relative to the slicer body, the knife having a peripheral cutting edge;
a food product support carriage mounted for movement back and forth past the slicer knife;
an adjustable gauge plate for varying slice thickness;
a carriage drive for effecting automated movement of the carriage back and forth past the slicer knife, the carriage drive comprising a linear motor having a forcer and a stator each having at least one magnetic field generator, the forcer movable along a linear path relative to the stator, the forcer mechanically linked with the carriage to effect automated movement thereof.

2. The food product slicer of claim 1 wherein the magnetic field generator of the forcer is formed by at least one energizable coil, the magnetic field generator of the stator is formed by a plurality of permanent magnet members arranged along a length of the stator.

3. The food product slicer of claim 1 wherein the food product slicer includes a user input for initiating an automatic slicing operation during which the energizable coil is energized to effect movement of the forcer and corresponding movement of the carriage, and during a manual slicing operation the energizable coil remains unenergized.

4. The food product slicer of claim 3 wherein the forcer remains mechanically linked with the carriage during the manual slicing operation, and transition from the automatic slicing operation to the manual slicing operation is achieved without any mechanical disengagement between the forcer and the carriage.

5. The food product slicer of claim 1, further comprising:
an encoder arrangement for providing an output for tracking position of the carriage along the carriage movement path;
a control connected with the carriage drive and the encoder arrangement, the control including memory for storing both a carriage stroke start position and a carriage stroke end position, enabling carriage stroke length to be set by adjusting the stored carriage stroke start position and/or the stored carriage stroke end position.

6. The food product slicer of claim 1, further comprising:
an encoder arrangement for providing an output for tracking position of the carriage along the carriage movement path;
a control connected with the carriage drive and the encoder arrangement, the control including memory for storing a carriage stroke start position, the control automatically identifying and storing the carriage stroke start position based upon location of the carriage at the time of a detected load condition indicative of food product moving into engagement with the slicer knife.

7. The food product slicer of claim 6 wherein the detected load condition is a motor load change.

8. The food product slicer of claim 1 including an elongated bulk food product loaded on the carriage.

9. The food product slicer of claim 1, further comprising:
an encoder arrangement for providing an output for tracking position of the carriage along the carriage movement path;
a control connected with the carriage drive and the encoder arrangement, the control including a speed maximizing control feature that operates to energize the motor in a manner to maximize slicing strokes per minute without exceeding a set motor parameter limit.

10. A food product slicer including a variable stroke length setting feature, the food product slicer comprising:
a slicer body;
a slicer knife mounted for rotation relative to the slicer body, the knife having a peripheral cutting edge;
a food product support carriage mounted for movement back and forth past the slicer knife along a carriage movement path;
an adjustable gauge plate for varying slice thickness;
a drive for automatically driving the carriage back and forth past the slicer knife for automatic food product slicing operations;
an encoder arrangement for providing an output for tracking position of the carriage along the carriage movement path;
a control connected with the drive and the encoder arrangement, the control including memory for storing both a carriage stroke start position and a carriage stroke end position, enabling carriage stroke length to be set by adjusting the stored carriage stroke start position and/or the stored carriage stroke end position.

11. The food product slicer of claim 10 including an elongated bulk food product loaded on the carriage.

12. A food product slicer including a variable stroke length setting feature, the food product slicer comprising:
a slicer body;
a slicer knife mounted for rotation relative to the slicer body, the knife having a peripheral cutting edge;
a food product support carriage mounted for movement back and forth past the slicer knife along a carriage movement path;
a drive for automatically driving the carriage back and forth past the slicer knife for automatic food product slicing operations;
an encoder arrangement for providing an output for tracking position of the carriage along the carriage movement path;
a control connected with the drive and the encoder arrangement, the control including memory for storing a carriage stroke start position, the control automatically identifying and storing the carriage stroke start position based upon automatically identifying location when the food product is positioned proximate to the peripheral cutting edge of the of the slicer knife.

13. The food product slicer of claim 12 wherein the location is automatically identified based upon a detected load condition indicative of food product moving into engagement with the slicer knife.

14. The food product slicer of claim 13 wherein the detected load condition is a motor load change.

15. The food product slicer of claim 14 wherein the motor load change is indicated by a detected change in an electrical parameter of at least one of a knife drive motor and a carriage drive motor.

16. The food product slicer of claim 15 wherein the electrical parameter is current level.

17. The food product slicer of claim 16 wherein the motor load change is indicated by current level of at least one of the knife drive motor and the carriage drive motor exceeding a threshold level.

18. The food product slicer of claim 16 wherein the motor load change is indicated by current level of both the knife drive motor and the carriage drive motor exceeding respective threshold levels.

19. The food product slicer of claim 13 wherein the detected load condition is indicated by at least one load sensor separate from both a knife drive motor and a carriage drive motor.

20. The food product slicer of claim 13 wherein the control includes memory for storing a carriage stroke end position, the control automatically identifying and storing the carriage stroke end position based upon location of the carriage at the time of a detected load condition indicative food product moving out of engagement with the slicer knife.

21. The food product slicer of claim 12 including an elongated bulk food product loaded on the carriage.
